(19) United States
(12) Patent Application Publication
(10) Pub. No.: US 2007/0066454 A1
(43) Pub. Date: Mar. 22, 2007

(54) Abdominal trainer

(76) Inventor: John Foley, Montclair, NJ (US)

Correspondence Address: DICKSTEIN SHAPIRO LLP, 1177 AVENUE OF THE AMERICAS (6TH AVENUE), NEW YORK, NY, 10036-2714, US

(21) Appl. No.: 11/521,357

(22) Filed: Sep. 15, 2006

Related U.S. Application Data
(60) Provisional application No. 60/718,055, filed on Sep. 16, 2005.

(51) Int. Cl. A61H 3/04; A63B 21/00; A47D 13/04

(52) U.S. Cl. 482/92; 482/68

(57) ABSTRACT

Abdominal fitness equipment includes a seat platform, a foot platform with attached bottom wheels, and a track rod that connects into receptacles in both the seat and foot platforms. The track rod acts as a guide so the foot platform will move in a straight line to and from the seat platform and also act as an anchor prevent the tendency of the foot platform to lift off the ground during the sit-up motion. The user sits on the seat platform with the user's feet secured in the straps of the foot platform enabling the user to do the action of crunch sit-ups and simultaneously pulling in the knees in toward the user's chest. Various degrees of resistance can be applied by simply adjusting the brake-like device which rests against the rear wheels. This will add a level of resistance making it more difficult to pull the foot platform in towards the chest and thus increasing the effects of the overall exercise. When the abdominal device is not in use it becomes its own portable suitcase providing an easy way to transport or to store. The seat platform and the foot platform are the same dimensions and will fit together with an open hinge on one end and a locking clip on the other end. A handle molded thru both the seat and the foot platforms act as a carrying handle when folded up. The track rod is a telescopic rod will be removed from the platform receptacles, be collapsed, and stored inside the suitcase. The bottom wheels of the foot platform will be on the inside of the suitcase when the fitness equipment is folded up.

### CROSS-REFERENCE TO RELATED APPLICATION

This application claims benefit under 35 U.S.C. § 119(e) of U.S. Provisional Application No. 60/718,055, filed Sep. 16, 2005, the entire contents of which are incorporated by reference herein.

### BACKGROUND OF THE INVENTION

1. Field of the Invention

The present invention relates to fitness equipment and more specifically to an abdomen fitness equipment.

### SUMMARY OF THE INVENTION

Abdominal fitness equipment in accordance with the present invention enables the user to exercise the action of sit-ups, with less effort and less stress on the lower back. Effectiveness of the exercise is increased in accordance with the present invention by utilizing a broader range of motion between the upper body and the lower body. By pulling the feet and knees into the body while simultaneously doing the traditional crunch sit-up motion, the user works the lower abdominal muscles and the upper abdominal muscles.

One object of the present invention is to provide a fitness equipment which enables a user to exercise the action of crunch sit-ups to work the upper part of the user's abdominals while motioning the legs in toward the chest on a wheeled platform. It is another object of the present invention, to provide a fitness equipment where the movable action of the foot platform can be adjusted to increase or decrease the amount of difficulty in pulling the legs towards the chest and back down.

It is another object of the present invention to provide a fitness equipment that is collapsible and can fold up into its own portable suitcase when not in use and that can be easily transported or stored.

According to one aspect of the present invention, the abdominal fitness equipment preferably provides two platforms, a seat platform, and a wheeled foot platform with foot straps. The user sits on the seat platform with legs stretched horizontally, with feet fastened into the straps of the wheeled foot platform. The wheels of the foot platform allow the user to pull the knees and legs in towards the user's chest, working the lower abdominals.

According to another aspect of the present invention, the seat platform allows the user to sit and perform the action of traditional sit-ups.

According to another aspect of the present invention, the fitness equipment preferably includes a track rod, which is telescopic, which can be attached to the seat and foot platform to provide stability and direction to the foot platform when being pulled into the user's chest. The track rod can be removed from the platform receptacles, be collapsed, and stored inside the suitcase.

According to another aspect of the present invention, the fitness equipment preferably provides a folding foot rest with foot straps to accommodate a more comfortable angle of the feet while strapped onto the platform.

According to another aspect of the present invention, the fitness equipment preferably provides a handle to lift and transport the folded suitcase. According to another aspect of the present invention, the fitness equipment preferably provides an adjustable brake-like resistance system which makes contact with the wheels to provide varied level of difficulty in moving the foot platform.

In accordance with an aspect of the invention, there is provided an exercise device comprising: a seat portion; an extendible telescoping portion; and a foot platform. The telescoping portion is operable to selectively engage both the seat portion and the foot platform, the seat portion and the foot platform being operable to move relative to one another between a first position, in which the foot portion and the seat portion are relatively close to one another, and a second position, in which the foot platform and the seat portion are relatively further apart from one another, the foot platform further including an adjustment portion that adjust the amount of force necessary to move between the first and second positions.

In accordance with another aspect, there is provided an exercise device comprising: a seat portion; and a wheeled foot platform, the exercise device being collapsible such that the seat portion and the wheeled foot platform together form a suitcase-like carrying structure

### BRIEF DESCRIPTION OF THE DRAWINGS

For the purposes of illustrating the present invention, there is shown in the drawings an illustrative form, it being understood however, that the invention is not limited to the precise form shown by the drawings in which:

FIG. 1 is a view of the top and right side of the fitness equipment according to an embodiment of the present invention when standing upright and as a closed suitcase.

FIG. 2 is a view of the top of the fitness equipment according to an embodiment of the present invention when standing upright and as a closed suitcase.

FIG. 3 is a view of the bottom side of the fitness equipment according to an embodiment of the present invention when standing upright as a closed suitcase.

FIG. 4 is a profile view of the front and top sides of the fitness equipment according to an embodiment of the present invention when sitting flat on the bottom side as a closed suitcase.

FIG. 5 is a transparent view of the front side fitness equipment according to an embodiment of the present invention when sitting flat on the bottom side as a closed suitcase.

FIG. 6 is a transparent view of the side of the fitness equipment according to an embodiment of the present invention when sitting flat on the bottom side as a closed suitcase.

FIG. 7 is an elevational view of the top and left side of the foot platform of the fitness equipment according to an embodiment of the present invention when opened and ready for use.

FIG. 8 is an upward view of the bottom side of the foot platform of the fitness equipment according to an embodiment of the present invention when opened and ready for use.

FIG. 9 is a view of the left and top sides of the foot platform, seat platform, and track rod of the fitness equipment according to an embodiment of the present invention when opened and ready for use.

FIG. 10 is an upward view of the bottom and left sides of the foot platform, seat platform, and track rod when opened and ready for use.

### DETAILED DESCRIPTION OF AN ILLUSTRATIVE EMBODIMENT

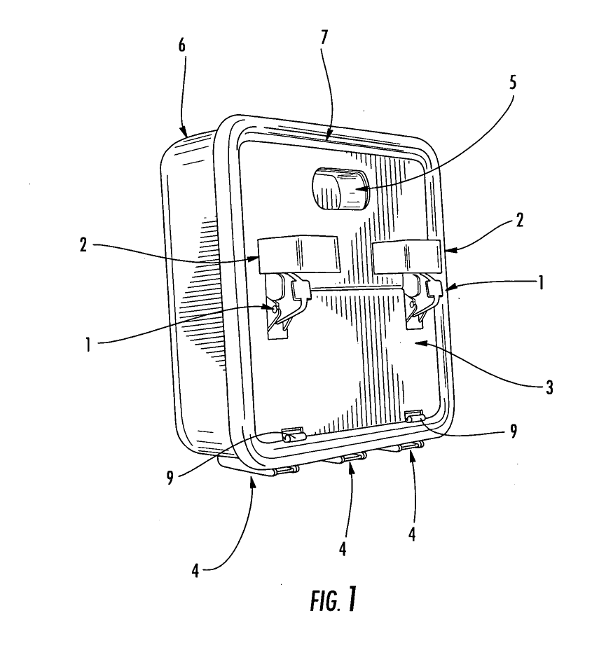

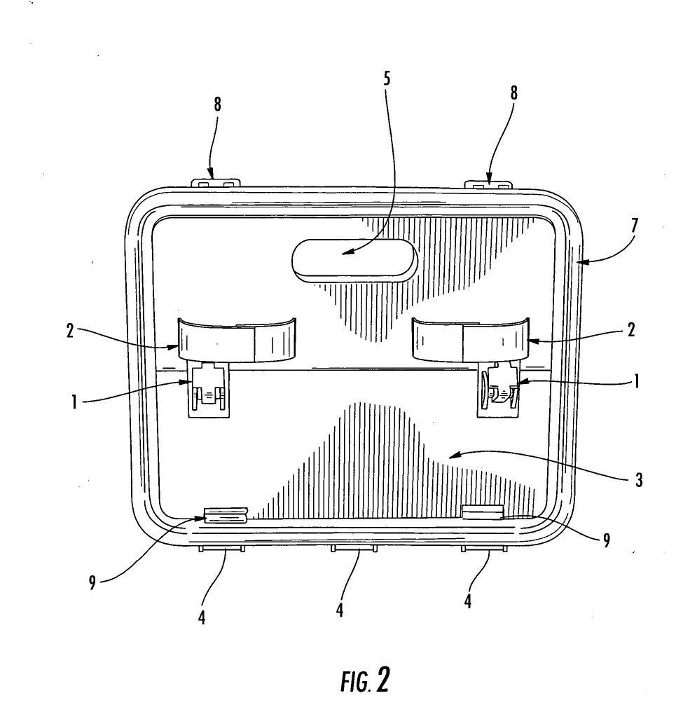

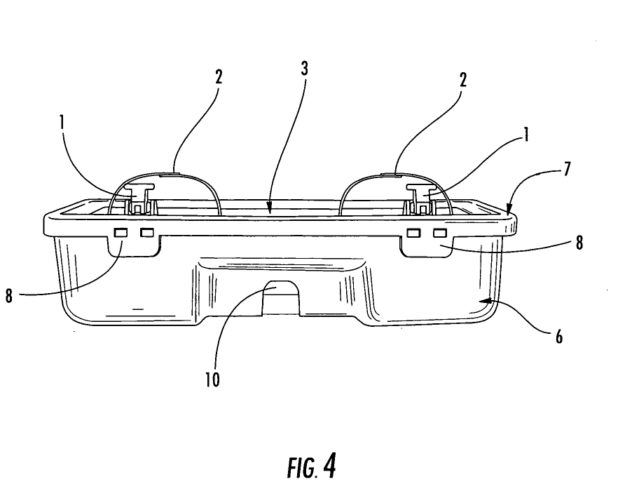

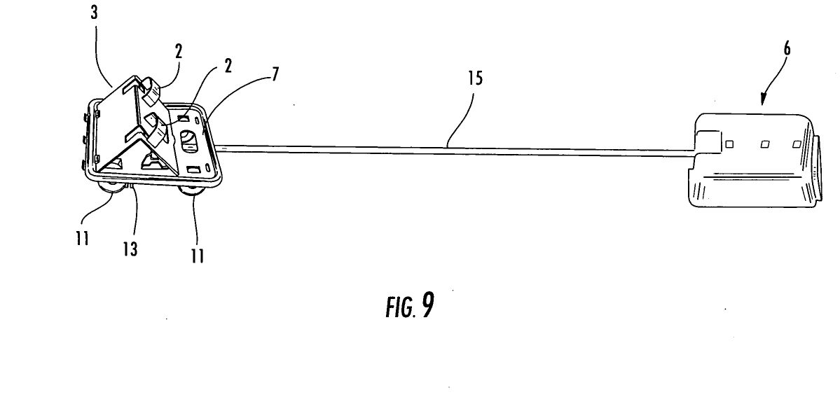

Referring to FIGS. 1-10, an illustrative embodiment of the abdominal fitness equipment generally includes a seat platform 6 and a foot platform 7 and a telescopic track rod 15. The foot platform 7 and the telescopic track rod 15 can be stored in the structure that functions as the seat platform to form a suitcase-like fitness device. This allows the entire abdominal fitness equipment to be easily stored and transported when not in use.

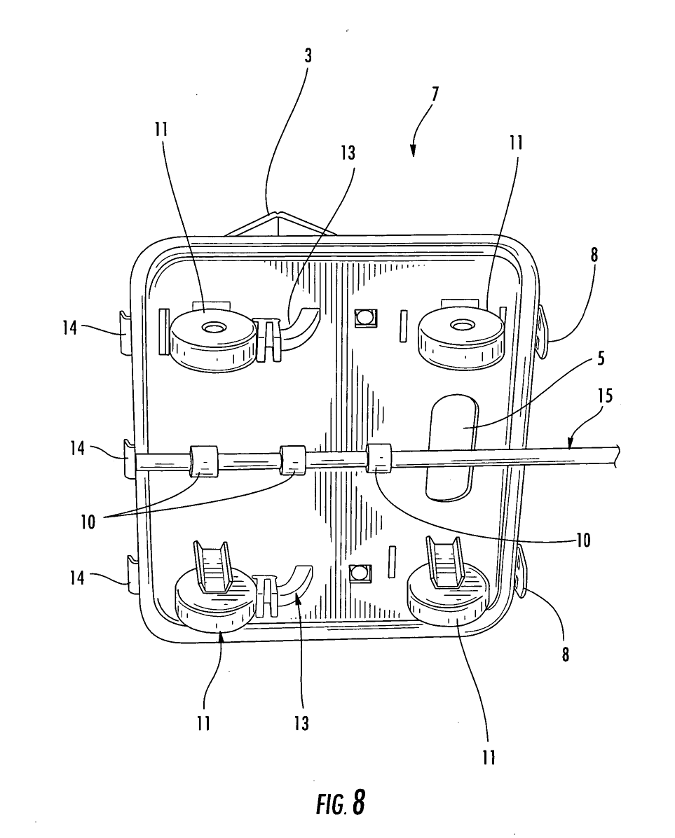

The foot platform 7 preferably includes two feet straps 2 to secure the feet to the platform, two adjustable brake-like devices 1 to provide tension against the back wheels 11 and increasing the resistance when the brake pads 13 are up against the wheel in motion. The foot platform also preferably includes a folding foot rest 3 hinged at 9 to provide a more comfortable angle for user to rest and secure the feet. Referring to FIG. 8 the underside of the foot platform preferably includes molded loops 10 to guide and secure the foot platform along the track rod 15 while in motion.

The foot platform also preferably includes the male end of hinges 14 to use when opening or closing the suitcase-like fitness device with locking tabs 8 to prevent the suitcase from opening when it is closed. A molded cutout 5 forms a handle to carry and transport the suitcase.

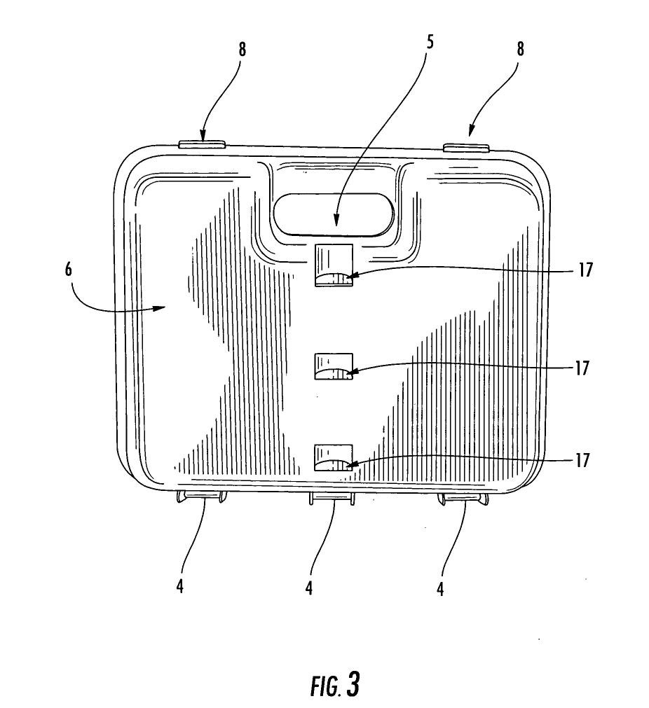

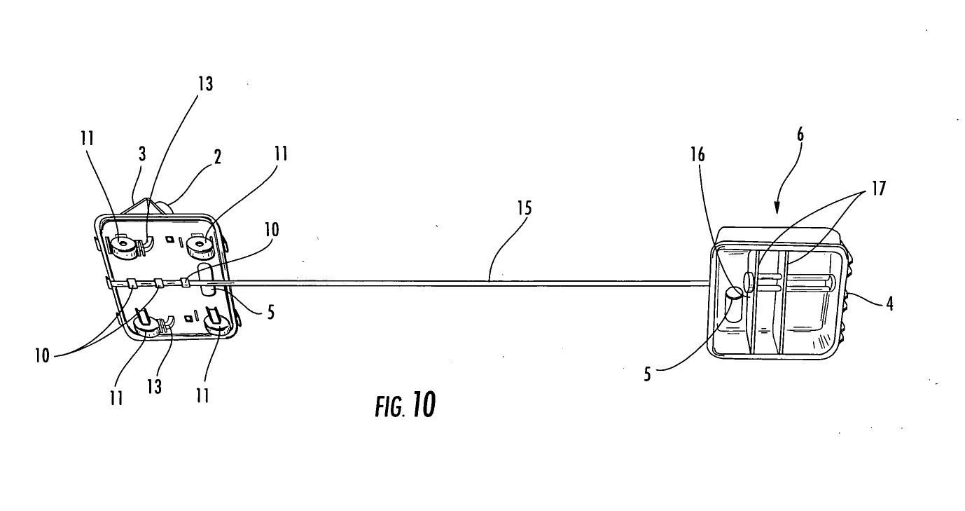

Referring to FIG. 3, the topside of the seat platform 6 preferably includes the exposed molded guides 17 to anchor the track rod into the underside of the foot platform. The seat platform has a molded hand cutout to act as a handle. When not in use the seat and foot platform come together and hinge closed at 4. Referring to FIG. 10, the underside of the seat platform has ribs 16 to provide extra strength to the molded seat.

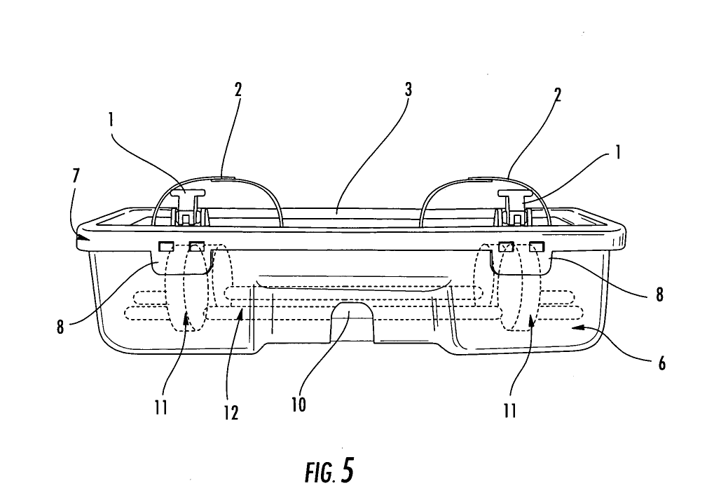

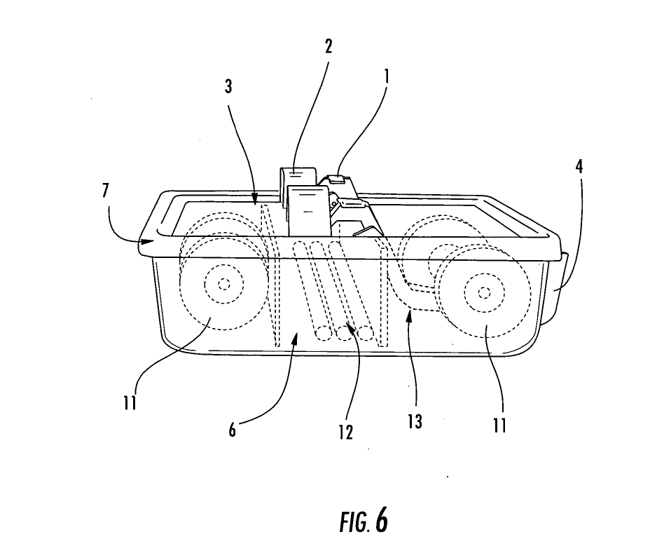

FIGS. 5 and 6 show a transparent view of the fitness equipment when not in use, in which the foot platform and the seat platform come together and fold up into a suitcase. The wheels 11 and the closed telescopic track rod 15 easily fit into the closed suitcase, preferably formed by storing the track rod 15 and foot platform 7 in the seat platform 6, as shown.

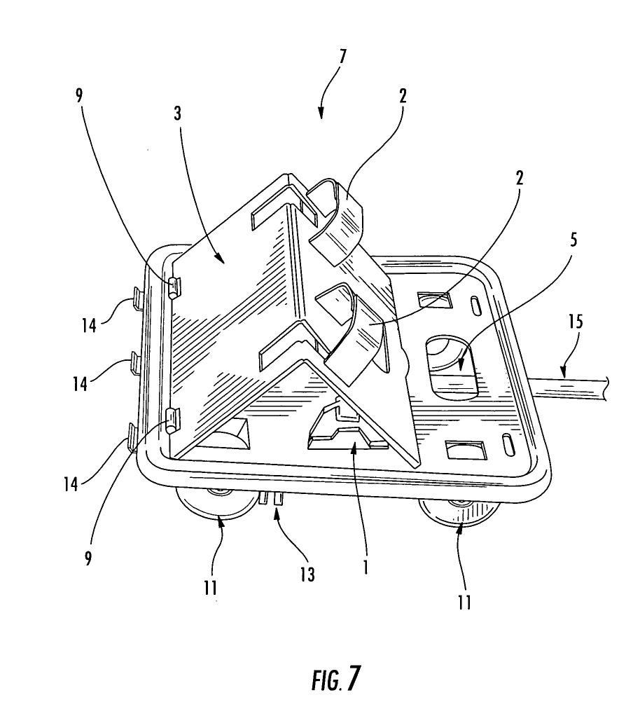

FIGS. 7-10 show the abdominal trainer when the components have been removed from the suitcase, and are assembled for use to perform exercises. In this configuration, the feet of the user would preferably be secured in feet straps and the foot platform 7, which is preferably coupled with the seat platform 6, on which the user is sitting, by the telescoping portion 15 which facilitates the abdominal trainer to move generally between a closed position, in which the seat platform 6 is relatively close to the foot platform 7, corresponding to when a user brings his or her feet close to his or her torso during an abdominal crunch, and an open position, in which the foot platform 7 is relatively further away from the seat platform 6, corresponding to when the user moves his or her feet further from his or her torso when doing an abdominal crunch, for example. The telescoping portion is not necessary for the movement between the first and second positions. The telescoping portion provides stability to the assembled exercise device and direction to the movement between the first and second positions, and, positions anywhere between.

Movement between these two positions, and positions in between, is facilitated by the wheels of the foot platform, and further facilitated by the telescoping portion 15, which allows the foot platform 7 and seat platform 6 to move closer and further apart from one another to assist in doing abdominal exercises, e.g., in a relatively straight line, as described above.

While the foregoing description and drawings represent an illustrative embodiment of the present. invention, it will be understood that various additions, modifications, and substitutions may be made therein without departing from the spirit and scope of the present invention as defined in the accompanying claims. Therefore, the present invention is not limited to only the embodiments specifically described herein. In particular, it will be clear to those skilled in the art that the present invention may be embodied in other specific forms, structures, arrangements, proportions, and with other elements, materials, and components, without departing from the spirit or essential characteristics thereof. One skilled in the art will appreciate that the invention may be used with many modifications of structure, arrangement, proportions, materials, and components and otherwise, used in the practice of the invention, which are particularly adapted to specific environments and operative requirements without departing from the principles of the present invention. The presently disclosed embodiment is therefore to be considered in all respects as illustrative and not restrictive, the scope of the invention being indicated by the appended claims, and not limited to the foregoing description.

What is claimed is:

1. An exercise device comprising:
a seat portion;
an extendible telescoping portion; and
a foot platform, the telescoping portion being operable to selectively engage both the seat portion and the foot platform, the seat portion and the foot platform being operable to move relative to one another between a first position, in which the foot portion and the seat portion are relatively close to one another, and a second position, in which the foot platform and the seat portion are relatively further apart from one another, the foot platform further including an adjustment portion that adjust the amount of force necessary to move between the first and second positions.

2. The exercise device according to claim 1, wherein the foot platform further comprises wheels to facilitate movement between the first and second positions and wherein the adjustment portion comprises an adjustable brake-like resistance system which makes contact with the wheels to provide varied level of difficulty in moving the foot platform between the first and second positions.

3. The exercise device according to claim 1, wherein the seat portion is formed so as to allow storage of the foot platform and the telescoping portion within the seat portion so as to form a suitcase-like case for the exercise device in a disassembled state.

4. The exercise device according to claim 1, wherein the foot platform further comprises foot straps for securing the feet of a user to the exercise device.

5. The exercise device according to claim 3, wherein the telescoping portion can be disengaged from the foot platform and seat portion, be collapsed, and stored inside the suitcase-like case.

6. The exercise device according to claim 4, wherein the exercise device is structured to facilitate exercise by allowing the user to sit on the seat portion with legs stretched horizontally, with feet fastened into the foot straps of the foot platform, the foot platform further comprising wheels allowing the user to pull the knees and legs in towards the user's chest, working the lower abdominals.

7. The exercise device according to claim 2, where the foot platform includes a folding portion that allows adjustments to the foot angle of a user of the exercise device.

8. An exercise device comprising:
a seat portion; and
a wheeled foot platform, the exercise device being collapsible such that the seat portion and the wheeled foot platform together form a suitcase-like carrying structure.

9. The exercise device according to claim 8, further comprising a telescoping track rod, attachable to the seat portion and the wheeled foot platform, which, when attached to the seat portion and the wheeled foot platform, provides stability and direction to the foot platform when being pulled toward the seat portion, the track rod being removable from attachment to the seat portion and foot platform, and collapsed for storage inside the suitcase.
